(19) United States
(12) Patent Application Publication
(10) Pub. No.: US 2025/0372317 A1
(43) Pub. Date: Dec. 4, 2025

(54) LOW AND MEDIUM VOLTAGE SWITCHING APPARATUS

(71) Applicant: ABB S.p.A., Milano (IT)

(72) Inventors: James Mannekutla, Västerås (SE); Johan Nohlert, Västerås (SE); Thomas Eriksson, Bälinge (SE); Lars Jonsson, Västerås (SE); Alessio Bergamini, Gazzaniga (BG) (IT); Mrunal Parekh, Åkersberga (SE); Johanna Navarrete-Emretsson, Bålsta (SE); Ilario Triscari, Västerås (SE)

(21) Appl. No.: 19/220,440

(22) Filed: May 28, 2025

(30) Foreign Application Priority Data
May 31, 2024 (EP) 24179375.1

(51) Int. Cl. H01H 9/02; H01H 1/22; H01H 9/34

(52) U.S. Cl. CPC H01H 9/02; H01H 1/22; H01H 9/34

(57) ABSTRACT

A switching apparatus is disclosed which comprises at least a fixed contact and a movable contact which can be coupled to/uncoupled from each other between a closed position and an open position. The apparatus further comprises an insulating assembly having a first barrier and a second barrier having corresponding first and second windows. The first and second barriers are coaxially positioned with respect to each other and are rotationally movable between a first position and a second position. In the first operative position the first and second windows are aligned with each other and in the second operative position the first and second windows are misaligned. When the fixed and movable contacts are in the closed position, the first and second barriers are in the first position, and when the fixed and movable contacts are in the open position, the first and second barriers are in the second position.

### CROSS REFERENCE TO RELATED APPLICATIONS

The present application claims priority to European Patent Application No. 24179375.1 filed on May 31, 2024, and titled “LOW AND MEDIUM VOLTAGE SWITCHING APPARATUS”, which is hereby incorporated by reference in its entirety.

### TECHNICAL FIELD

The present disclosure relates to the field of electrical systems, such as electric grids, switchboards, and the like. More particularly, the present disclosure relates to a switching apparatus, such as, e.g., circuit breakers, disconnectors, contactors for low-or medium-voltage electrical systems.

### BACKGROUND

For the purposes of the present disclosure, the term Low Voltage is intended to designate electrical systems operating at voltage levels up to 1 kV AC and 1.5 kV DC, while the term Medium Voltage is intended to designate electrical systems operating at voltage levels higher than 1 kV AC and 1.5 kV DC up to some tens of kV, e.g., up to 72 kV AC and 100 kV DC.

As it is known, an electrical system may include several switching apparatuses configured in such a way to allow a selective disconnection of electrical sections, for example when a fault event occurs.

Many switching apparatuses of the state of the art are of electromechanical type.

In general, these switching apparatuses have the advantage of ensuring a galvanic isolation between disconnected electric circuits. Additionally, they are relatively cheap to realize at industrial level.

It is known that switching apparatuses, such as for example circuit breakers, disconnectors, contactors, limiters, hereinafter referred to, for reasons of brevity, as switches, comprise one or more electrical poles, associated to each of which there is at least one pair of contacts that can be coupled to and uncoupled from one another. Switches of the known art also comprise control means that cause relative movement of said pairs of contacts so that they can assume at least one first, coupling, position (circuit closed) and one second, separation, position (circuit open). The control means comprise, for instance, mechanisms, which terminate, for example, in a shaft operatively connected to said mobile contacts.

In particular, the circuit breakers are usually provided with a system which ensures the nominal current required for the various users, the connection and disconnection of the load, protection against any abnormal conditions (such as overloading and short-circuit) by automatically opening the circuit, and the disconnection of the protected circuit by opening the moving contacts with respect to the fixed contacts (galvanic separation) in order to achieve full isolation of the load with respect to the electric power source.

However, the experience has shown how these apparatuses do not often provide satisfactory interruption ratings, in particular when they must interrupt DC currents at relatively high voltages (e.g., 1.5 kV DC or above). In these circumstances, in fact, their opening time can be quite long. Electric arcs, which usually strike between electric contacts under separation, may consequently last for a relatively long time, which is quite dangerous as many electrical components (e.g. photovoltaic panels and energy storage systems) electrically connected to the electric line can potentially feed an undergoing electric fault.

Furthermore, it has been seen that electric arcs may sometime strike towards other conductive parts or components of the switching apparatus, which may be subject to serious damages since they are not generally designed to bear high electric and thermal stresses.

The above-mentioned inconveniences are even made more critical by the circumstance that, in modern electrical systems, switching apparatuses are often brought to operate to relatively high operating voltages. Electric arcs with a high energy content may thus arise between the electric contacts under separation during the opening maneuvers of a switching apparatus.

Due to the above-mentioned criticalities, currently available switching apparatuses typically comprise a relatively high number of switch poles electrically connected in series when operating at relative high voltages. They are thus rather expensive to manufacture at the industrial level and relatively difficult to install due to their huge size.

### BRIEF DESCRIPTION

The main aim of the present disclosure is to provide a switching apparatus for low or medium voltage electrical systems, which allows overcoming or mitigating the above-mentioned criticalities.

In particular, the present disclosure aims at providing a switching apparatus where the arching phenomena and the related problems can be easily managed.

More particularly, an object of the present disclosure is to provide a switching apparatus ensuring performant interruption ratings in case of electric faults, especially in presence of short-circuit currents. Additionally, it should be capable of interrupting low current or critical current.

As a further object, the present disclosure aims at providing a switching apparatus having a compact structure and easy to install on the field.

Still another object of the present disclosure is to provide a switching apparatus, which can be easily manufactured at industrial level, at competitive costs relative to the solutions of the state of the art.

In order to fulfill these aim and objects, the present disclosure provides a switching apparatus, according to the following claim 1 and the related dependent claims.

In a general definition of the present disclosure, the switching apparatus for low and/or medium voltage applications, according to the present disclosure comprises at least an electrical pole which comprises at least a fixed contact and at least a movable contact which can be coupled to/uncoupled from each other between a closed position in which they are in contact with each other and an open position in which they are separated from each other by an opening gap. The switching apparatus, according to known embodiments, further comprises first actuating mean for moving the movable contact between said open and closed positions. The first actuating means can be of any type according to the operational needs and applications and will not be described in further details.

The movable contact may be linearly or rotationally movable between said open and closed positions according to known design features that may vary according to the operational needs and applications.

The switching apparatus of the present disclosure is characterized in that it comprises an electrical insulating assembly which in turn comprises a first barrier element and a second barrier element which are each provided with at least a corresponding first and second insulating wall having a corresponding first and second window.

In particular, the first and second barrier element are coaxially positioned with respect to each other along a longitudinal axis and are rotationally movable with respect to each other around said longitudinal axis between a first operative position and a second operative position.

In the first operative position, said first and second window are aligned with each other while in the second operative position said first and second window are misaligned with respect to each other, i.e., they do not overlap with each other.

In the switching apparatus of the present disclosure, when said fixed and movable contacts are in the closed position, said first and second barrier element are in the first operative position with the first and second windows aligned in correspondence of said opening gap, while when the fixed and movable contacts are in the open position, the first and second barrier elements are in the second operative position in which the first and second window are misaligned with respect to each other and in which at least one the first and second insulating walls of the first and second barrier element overlaps said opening gap.

For the purposes of the present disclosure, the features “rotationally movable with respect to each other” referred to the first and second barrier element, is meant to designate situations where there is a relative rotational movement between the barriers, i.e., when one of the barriers is fixed and the other barrier rotates with respect to it and when both barriers rotates—in particular counter-rotate—around a longitudinal axis.

In this way, as better described hereinafter, in the switching apparatus of the present disclosure, the design and the positioning of the electrical insulating assembly-and in particular, the design and functioning principles of first and second barrier element-provides an efficient system for controlling the arcing phenomena during opening/closing operation of the switching apparatus.

In the following detailed description, the present disclosure will be described with reference to a low voltage switch, e.g. a Circuit Breaker, which is provided with an electrical insulating assembly equipped with the relevant rotating barrier elements but, in general, it can be applied to any type of low or medium voltage switching apparatuses depending on the applications and operational needs.

In practice, in the first operative position the first and second barrier elements are capable of assuming a first relative position, in which the first window of said first barrier element and the second window of said second barrier element are aligned with each other and allow passage of the movable contact so that said movable contact can couple with or decouple from said fixed contact.

Then, in the second operative position, the first and second barrier elements are capable of assuming a second relative position, in which the first window of said first barrier element and the second window of said second barrier element are misaligned with each other and the first and/or second insulating walls of said first and second barrier elements are interposed between movable and fixed contacts and form a dielectric barrier in the opening gap between said movable contact and said fixed contact.

Moreover, due to the design of the barriers, the electrical arc is squeezed along a tortuous path and can be efficiently controlled even in case of relatively high energy release like, e.g., under short circuit conditions.

As further explained in the following detailed description of some embodiments—in general embodiments of the switching apparatus of the present disclosure, the first and/or the second barrier element moves from the first operative position to the second operative position when the movable contact moves from the closed position to the open position, thereby closing the opening gap between the contacts and creating a tortuous path for the electrical arc.

Conversely, when the movable contact moves from the open position to the closed position, the first and/or second barrier element moves from the second operative position to the first operative position, thereby freeing the opening gap and allowing passage of the movable contact so that it can couple with the fixed contact and the contact system can reach the closed configuration.

In general embodiments and depending on the operational needs, a number of barrier elements and/or corresponding insulating walls greater that two can be used to increase the effectiveness of the system.

In practice, according to embodiments of the switching apparatus of the present disclosure, the system is provided with second actuating means for moving said first and/or second barrier element between said first operative position and said second operative position.

The second actuating means of the barrier element(s) are conveniently synchronized with the first actuating means of the movable contact so that the above-described coordinated movement of the barrier element(s) with respect to the movable contact movement can be achieved.

The second actuating means of the barrier element(s) can be, e.g., a kinematic link connecting the barrier element(s) to the first actuating means of the movable contact, so that movement of the barrier element(s) is driven by the first actuating means of the movable contact and a proper coordination between the movement of the barrier(s) and of the movable contact can be guaranteed. The kinematic link between the barrier element(s) and the first actuating means of the movable contact can be designed according to the operational needs and applications and will not be described in further details.

According to embodiments of the switching apparatus of the present disclosure, said first barrier element is fixed with respect to the fixed contact and said second barrier element rotates with respect to said first barrier element between said first and second operative positions. In other words, in these embodiments the first window in the first barrier element is kept fixed in correspondence of the opening gap between the contacts while second barrier element rotates, thereby aligning or moving away the second window with respect to the first window and consequently assuming the first or the second operative positions.

Alternatively, in other embodiments of the switching apparatus of the present disclosure, said first and second barrier element are movable with respect to said fixed contact and counter-rotate with respect to each other between said first and second operative position. In practice in these embodiments, in the first operative position the first and second windows are aligned in correspondence with the opening gap and allow coupling between the fixed and movable contacts. Following an opening command—and in coordination with the movement of the movable contact—said first and second barrier elements counter-rotate with respect to each other, thereby misaligning the first and second windows and interposing their first and second insulating walls between the movable and fixed contacts to create a dielectric barrier between the contacts and a tortuous path for the electrical arc.

In some embodiments of the switching apparatus of the present disclosure, the first barrier element comprises an insulating body provided with an internal volume which houses the fixed contact, and which is open on one side of said insulating body.

The insulating body is further provided with a first cylindrical slot which is open on the opposite side of said insulating body with respect to said internal volume; the first cylindrical slot and the internal volume are separated by the first insulating wall onto which said first window is formed.

Then, according to some embodiments, said second barrier element comprises a first insulating cylinder which is open on a first side (base), and which is provided with a driving shaft on the opposite side (base) thereof. The lateral surface of said first insulating cylinder forms said second insulating wall and is inserted into said first cylindrical slot of said first barrier element, said second window being formed on said second insulating wall. In particular, the first insulating cylinder is inserted in free rotation into the first cylindrical slot so that the second barrier element, driven by the driving shaft, can rotate with respect to the first barrier element, thereby moving between the first and the second operative positions.

In some embodiments, the insulating body of the first barrier element may conveniently comprise a plurality of ventilation holes that put said first cylindrical slot and/or the opening gap between the contacts in communication with the outside of said insulating body.

According to some embodiments of the switching apparatus of the present disclosure, the insulating body of the first barrier element may be provided with at least a second cylindrical slot which is open on the opposite side of said insulating body with respect to said internal volume. In this case, the second cylindrical slot and said first cylindrical slot are separated by a third insulating wall onto which a third window is formed.

Then, according some embodiments, said second barrier element comprises a second insulating cylinder which is also open on one side (base), and which is positioned around said first insulating cylinder. The lateral surface of said second insulating cylinder forms a fourth insulating wall and is inserted into said second cylindrical slot of said first barrier element, a fourth window being formed on said fourth insulating wall.

In practice, in these embodiments, the second barrier element may be designed as a single body with the first insulating cylinder and second insulating cylinder respectively inserted in free rotation into said first and second cylindrical slots, so that the second barrier element, driven by the driving shaft, can rotate with respect to the first barrier element, thereby moving between the first and the second operative positions.

In these latter embodiments of the switching apparatus of the present disclosure, in the first operative position said first, second, third and fourth windows are conveniently aligned with each other while in the second operative position said first, second, third and fourth windows are conveniently misaligned with respect to each other.

Thus, when said fixed and movable contacts are in the closed position, said first and second barrier elements are in said first operative position with the first, second, third and fourth windows aligned in correspondence of said opening gap.

Then, when the fixed and movable contacts are in the open position, said first and second barrier elements are in the second operative position with the first, second, third and fourth windows misaligned and the first, second, third and fourth insulating walls of the first and second barrier elements overlapping one another in correspondence of said opening gap.

In some embodiments, said insulating body may be conveniently provided with a plurality of ventilation channels that put said first and second cylindrical slots in communication with the outside of said insulating body, thereby enhancing the release of thermal energy towards the outside of the insulating body.

In some embodiments of the switching apparatus of the present disclosure, an arc splitter assembly is present, said arc splitter assembly being provided with a plurality of arc splitter plates and in some embodiments with an arc rail extending from said opening gap between said fixed and movable contact towards said arc splitter plates. The arc splitter assembly may be conveniently positioned in operative communication with said opening gap between said fixed and movable contact, according to specific design configuration that may vary according to the operative needs and applications.

### BRIEF DESCRIPTION OF DRAWINGS

Further features and advantages of the present disclosure will be more apparent from the description of exemplary embodiments of the present disclosure, shown by way of examples in the accompanying drawings.

FIG. 1a is a perspective view of an embodiment of a switching apparatus, according to the present disclosure.

FIG. 1b is a section perspective view of the embodiment of the switching apparatus represented in FIG. 1a.

FIG. 2 is an exploded view of the embodiment of the switching apparatus represented in FIG. 1a and 1b.

FIG. 3a is a section view of the embodiment of the switching apparatus represented in the previous Figures, shown in the closed position.

FIG. 3b is a section view of the embodiment of the switching apparatus represented in the previous Figures, shown in the open position.

FIG. 4 is an exploded view of a first embodiment of an electrical insulating assembly used in a switching apparatus, according to the present disclosure.

FIG. 5a is section view of a second embodiment of a switching apparatus, according to the present disclosure.

FIG. 5b is a perspective view of a component of the electrical insulating assembly used in the switching apparatus of FIG. 5a.

FIG. 6 is a section perspective view of an embodiment of the switching apparatus, according to the present disclosure, in which the electrical insulating assembly of FIG. 5 is used.

FIG. 7a is a section view of a third embodiment of an electrical insulating assembly used in a switching apparatus, according to the present disclosure.

FIG. 7b is a perspective view of a third embodiment of an electrical insulating assembly used in a switching apparatus, according to the present disclosure.

FIG. 7c is an exploded view of a third embodiment of an electrical insulating assembly used in a switching apparatus, according to the present disclosure.

FIG. 8 is a section view of a further embodiment of a switching apparatus, according to the present disclosure.

FIG. 9 is a section view of a further embodiment of a switching apparatus, according to the present disclosure.

FIG. 10 is a perspective view of a further embodiment of a switching apparatus, according to the present disclosure.

FIG. 11 is a section view of the embodiment of a switching apparatus, according to the present disclosure, represented in FIG. 10.

FIG. 12 is a section view of a further embodiment of a switching apparatus, according to the present disclosure.

### DETAILED DESCRIPTION

With reference to the attached figures, the present disclosure—in its more general definition—relates to a switching apparatus for low and/or medium voltage applications designated in the various embodiments with the reference numeral 1.

The switching apparatus comprises at least an electrical pole which in turn comprises at least a fixed contact 2 and at least a movable contact 3 which can be coupled to/uncoupled from each other between a closed position in which they are in contact with each other and an open position in which they are separated from each other by an opening gap 4.

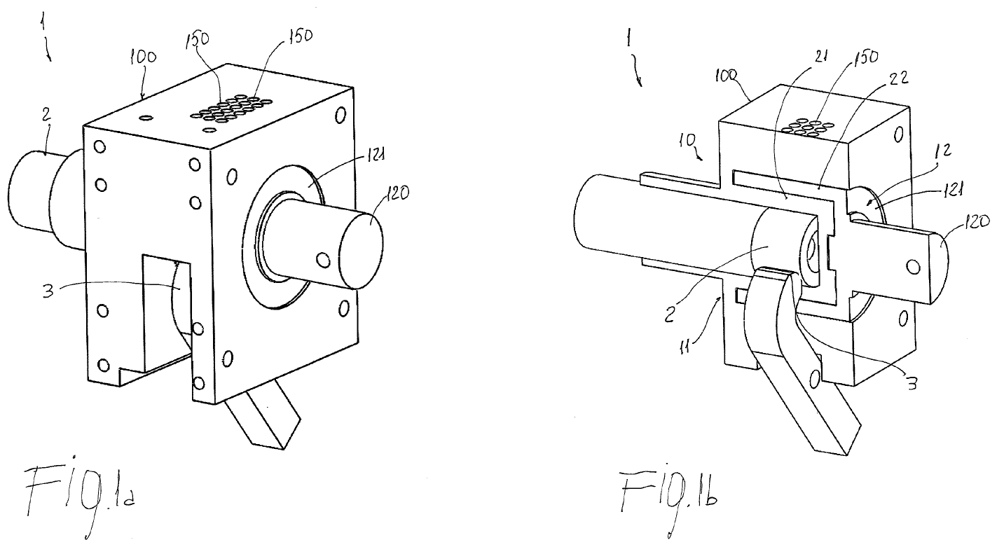

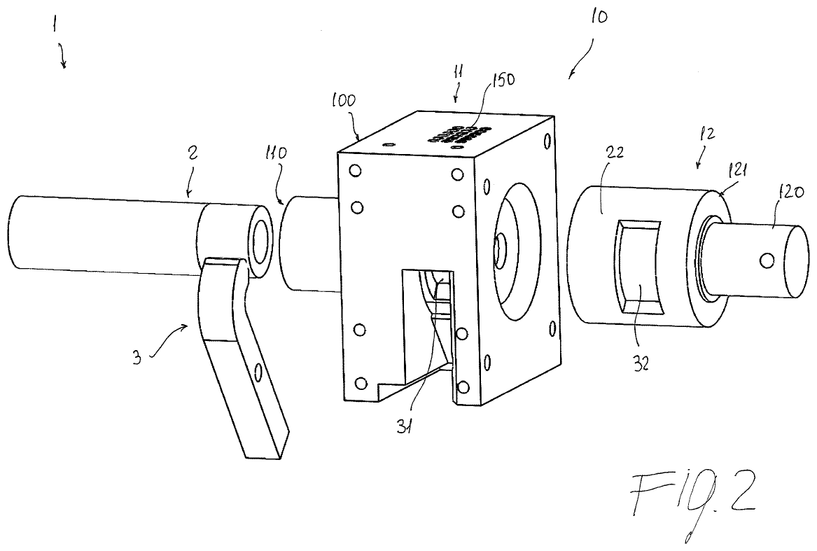

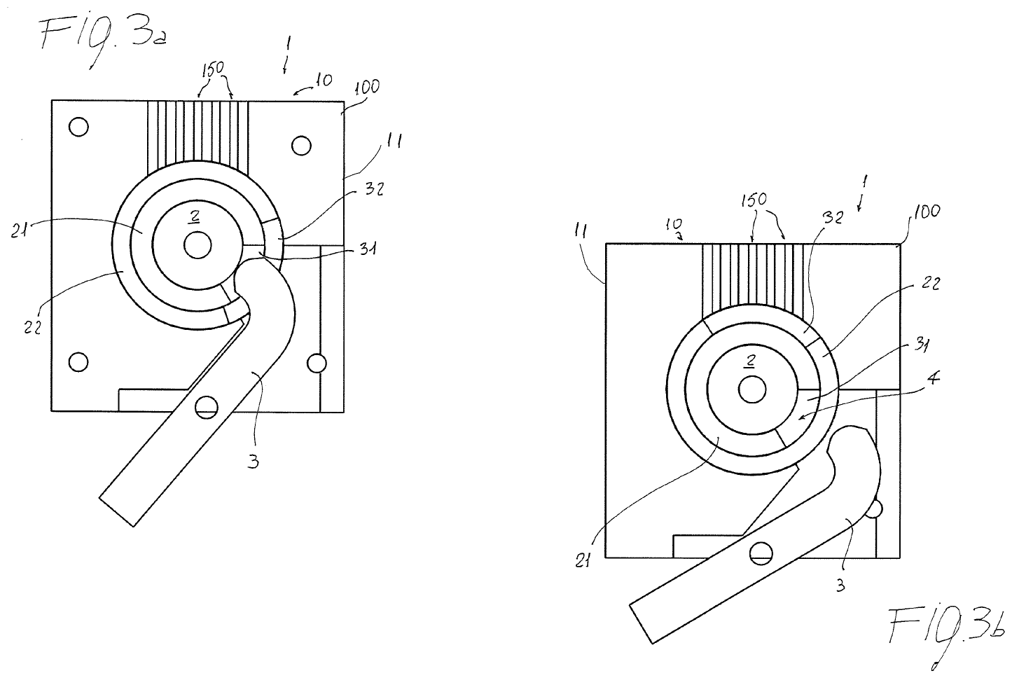

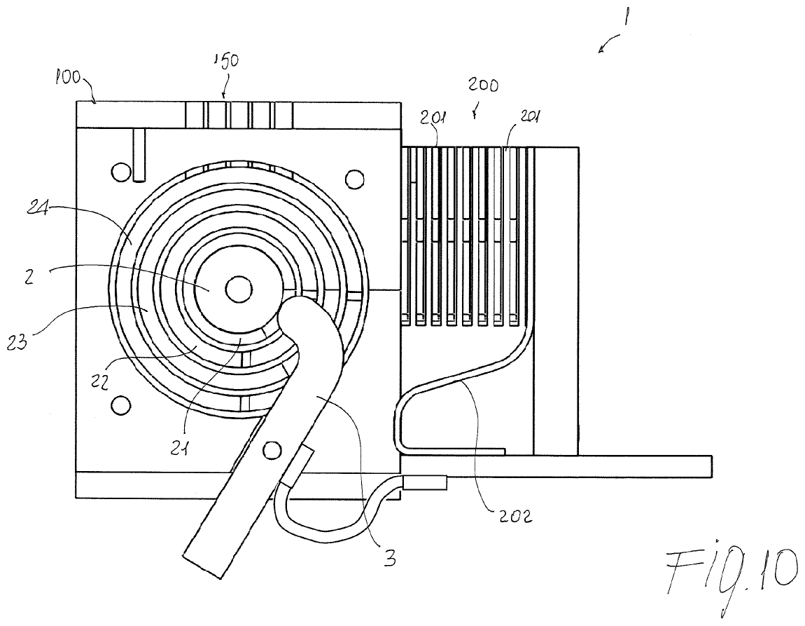

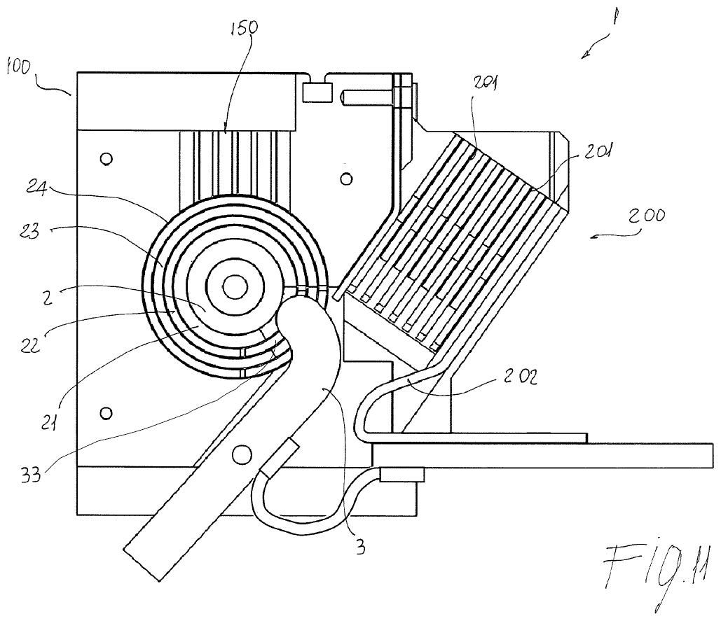

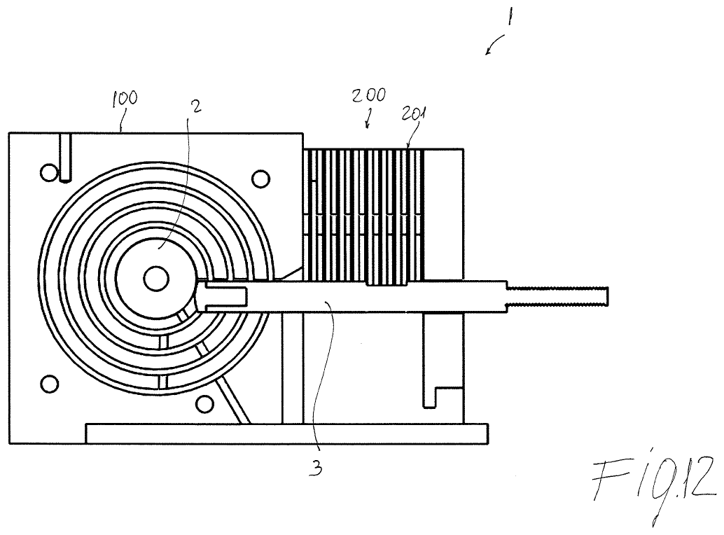

The movable contact 3 can be rotationally movable between said open and closed positions, as in the embodiments of FIGS. 1-11, or it can be linearly movable between said open and closed positions, as shown in FIG. 12.

The switching apparatus further comprises first actuating means for moving the movable contact 3 between said open and closed positions. The first actuating means of the movable contact 3 are not shown in the attached figures and can be of any type, according to the operational needs and applications.

A characterizing feature of the switching apparatus of the present disclosure is given by the fact that it comprises an electrical insulating assembly 10 comprising a first barrier element 11 and a second barrier element 12, which are rotationally movable with respect to each other as better described here below.

The first barrier element 11 and the second barrier element 12 are each provided with at least a corresponding first 21 and second 22 insulating wall, onto which a corresponding first 31 and second 32 windows are formed.

The first 11 and second 12 barrier elements are coaxially positioned with respect to each other along a longitudinal axis and around said opening gap 4. The first 11 and second 12 barrier elements are rotationally movable with respect to each other around said longitudinal axis between a first operative position—in which said first 31 and second 32 windows are aligned with each other—and a second operative position—in which said first 31 and second 32 windows are misaligned with respect to each other.

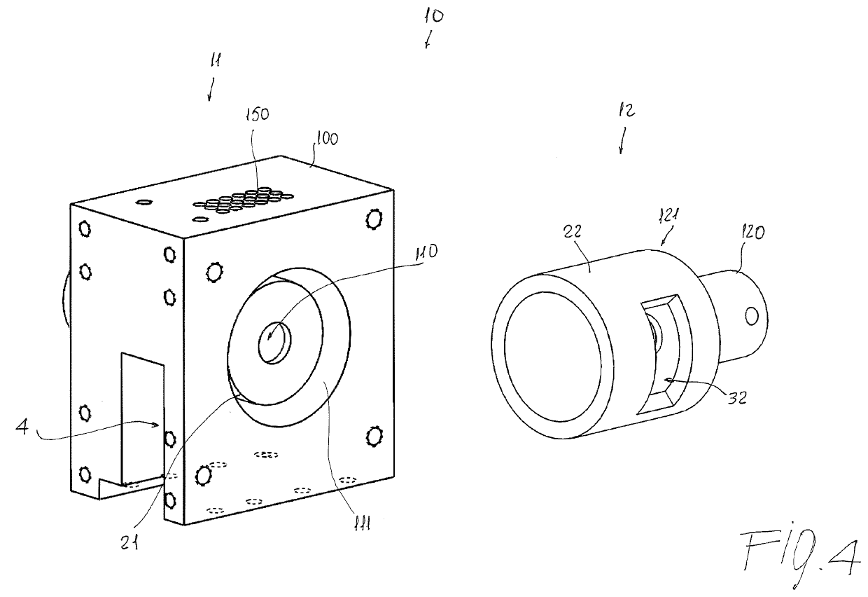

With particular reference to FIGS. 3a and 3b, when the fixed 2 and movable 3 contacts are in the closed position (FIG. 3a), said first 11 and second 12 barrier elements are in said first operative position with the first 31 and second 32 windows aligned in correspondence of said opening gap 4; when the fixed 2 and movable 3 contacts are in the open position (FIG. 3b), said first 11 and second 12 barrier elements are in said second operative position with the first 31 and second 32 windows misaligned and with the first 21 and second 22 insulating walls of the first 11 and second 12 barrier elements overlapping one another in correspondence of said opening gap 4, thereby creating an insulating barrier between the fixed 2 and movable 3 contacts and squeezing the electrical arc along a tortuous path.

In practice, the first 11 and/or second 12 barrier element moves from the first operative position to the second operative position when said movable contact 3 moves from the closed position to the open position, while the first 11 and/or second 12 barrier element moves from the second operative position to the first operative position when said movable contact 3 moves from the open position to the closed position.

In the embodiments of FIGS. 1-6 and 8-12, the first barrier element 11 is fixed with respect to said fixed contact 2, while the second barrier element 12 rotates with respect to said first barrier element 11 between said first and second operative positions.

Thus, with reference to FIGS. 3a and 3b, the first barrier element 11 is fixed with respect to the fixed contact 2 and said second barrier element 12 rotates with respect to said first barrier element 11 between said first (FIGS. 3a) and second (FIGS. 3b) operative positions. The first window 31 in the first barrier element 11 is therefore kept fixed in correspondence of the opening gap 4 between the contacts 2 and 3 while the second barrier element 12 rotates, thereby aligning (FIG. 3a) or moving away (FIG. 3b) the second window 32 with respect to the first window 31 and consequently assuming the first or the second operative positions.

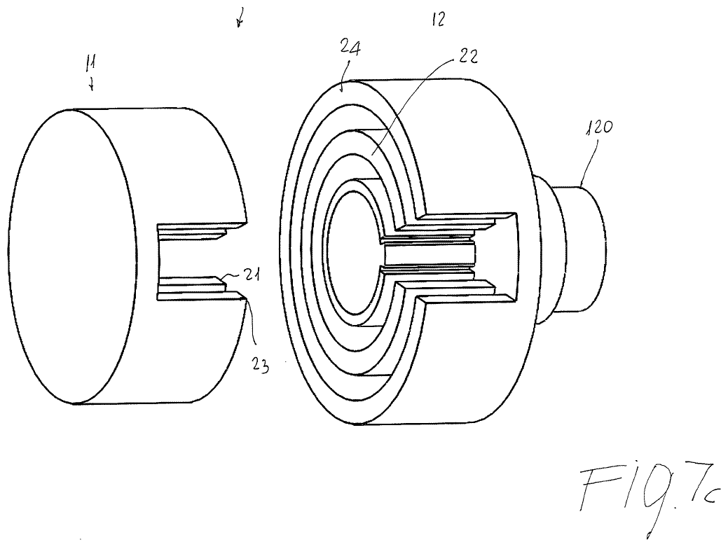

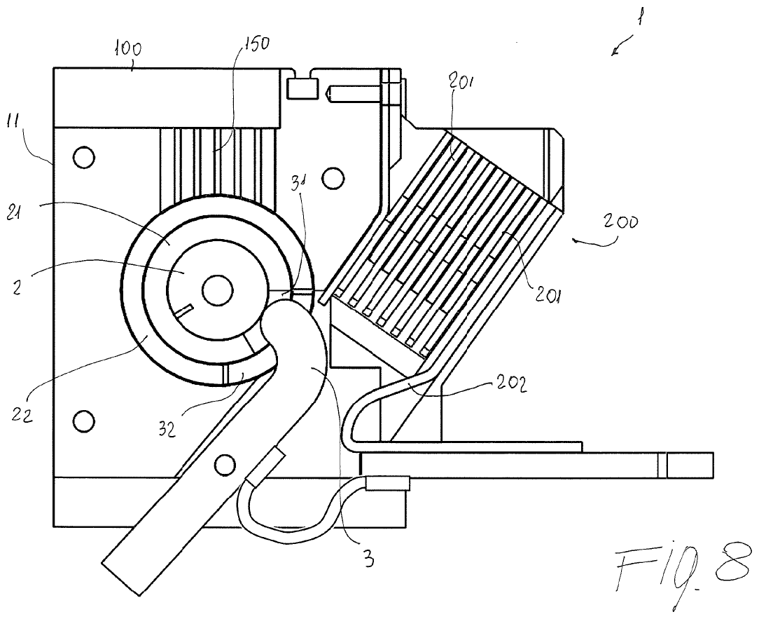

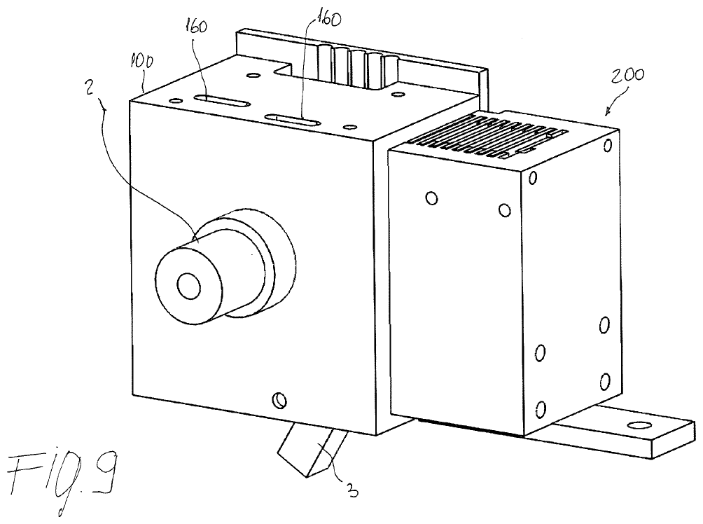

Alternatively, as shown in FIGS. 7a-7c, the first 11 and second 12 barrier elements are both movable with respect to said fixed contact 2 and counter-rotate with respect to each other between said first and second operative positions.

With particular reference to FIGS. 1-4 and 8, in design embodiments of the switching apparatus 1 of the present disclosure, the first barrier element 11 comprises an insulating body 100 provided with an internal volume 110 which houses the fixed contact 2 and which is open on one side of said insulating body 110.

The insulating body 100 is further provided with a first cylindrical slot 111 which is open on the opposite side of said insulating body 100 with respect to said internal volume 110. In particular, the first cylindrical slot 111 and the internal volume 110 of the insulating body 100 are separated by the first insulating wall 21 onto which the first window 31 of the first barrier element 11 is formed.

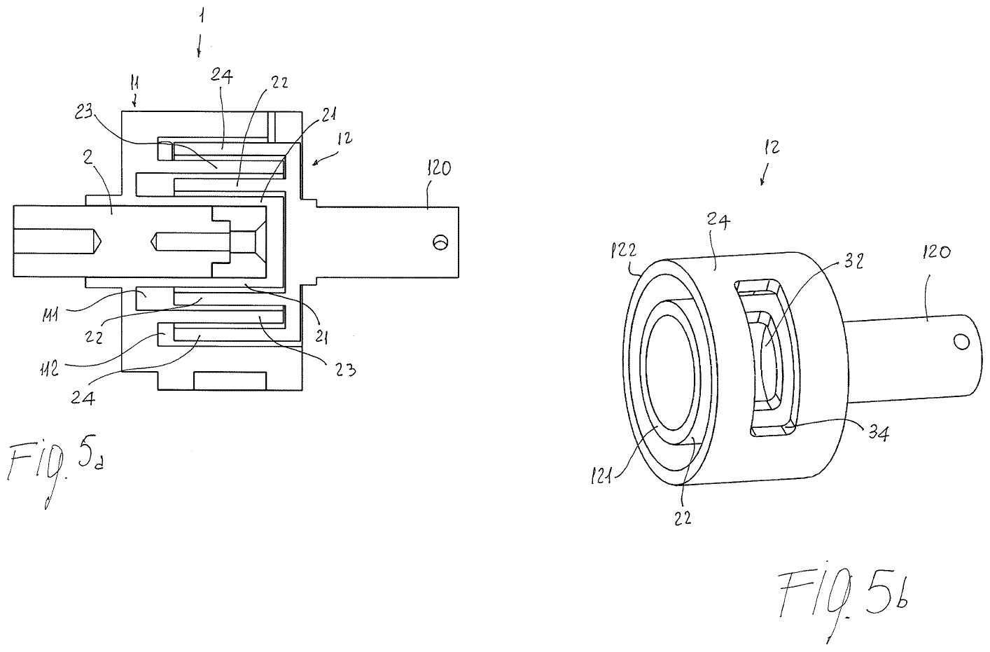

Then, with particular reference to FIG. 4, the second barrier element 12 typically comprises a first insulating cylinder 121 which has a base side open, and which is provided with a driving shaft 120 on the opposite base side.

The lateral surface of the first insulating cylinder 121 forms the second insulating wall 22 onto which the second window 32 of the second barrier element 12 is formed.

The lateral surface of said first insulating cylinder 121 forming the second insulating wall 22 is inserted in free rotation into the first cylindrical slot 111 of the first barrier element 11, so that the second barrier element 12, driven by the driving shaft 120, can rotate with respect to the first barrier element 11.

As shown in various embodiments in the attached figures, the insulating body 100 of the first barrier element 11 comprises a plurality of ventilation holes 150 that locate the cylindrical slot 111 and/or the opening gap 4 between the contacts 2 and 3 in communication with the outside of said insulating body 100.

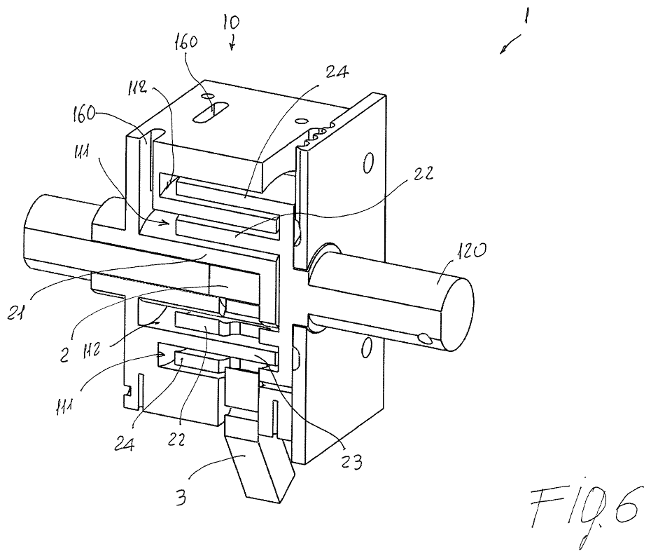

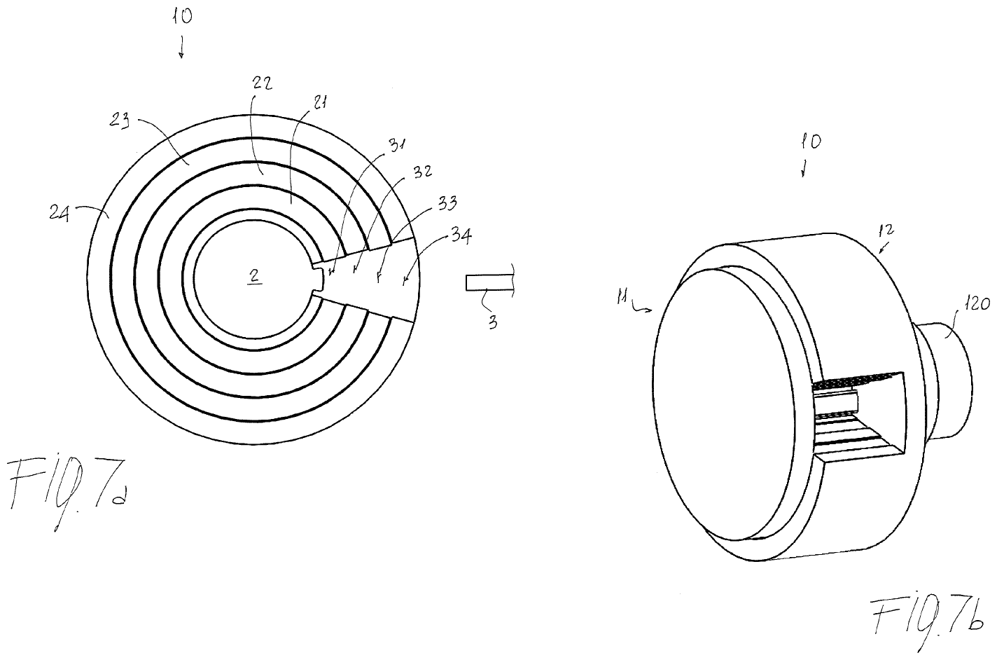

With particular reference to FIGS. 5-6 and 9-12, in further design embodiments of the switching apparatus 1 of the present disclosure the insulating body 100 of the first barrier element 11 is conveniently provided with a second cylindrical slot 112 which is open on the opposite side of the insulating body 100 with respect to the internal volume 110.

As shown in the attached figures, the second cylindrical slot 112 and the first cylindrical slot 111 formed in the insulating body 100 are separated by a third insulating wall 23 onto which a third window 33 is formed.

Then, with reference to FIG. 5b, the second barrier element 12 conveniently comprises a second insulating cylinder 122 which is also open on one side (base), and which is positioned around the first insulating cylinder 121. As shown in the mentioned figure, the second barrier element 12 may be conveniently formed as a single body.

The lateral surface of the second insulating cylinder 122 forms a fourth insulating wall 24 onto which a fourth window 34 is formed. The second insulating cylinder 122 is inserted into the second cylindrical slot 112 of the first barrier element, as shown in FIGS. 5a and 6.

In practice, in these embodiments, the second barrier element 12 is a single body with the first insulating cylinder 121 and the second insulating cylinder 122 respectively inserted in free rotation into the first cylindrical slot 111 and second cylindrical slot 112 of the first barrier element 11, so that the second barrier element 12, driven by the driving shaft 120, can rotate with respect to the first barrier element 11, thereby moving between the first and the second operative positions.

Therefore, in the first operative position the first 31, second 32, third 33 and fourth 34 windows are aligned with each other while in the second operative position said first 31, second 32, third 33 and fourth 34 windows are conveniently misaligned with respect to each other. Thus, when the fixed 2 and movable 3 contacts are in the closed position, as shown in FIGS. 5a and 6, the first 11 and second 12 barrier elements are in said first operative position with the first 31, second 32, third 33 and fourth 34 windows aligned in correspondence of said opening gap.

Then, when the fixed 2 and movable 3 contacts are in the open position (not shown), the first 11 and second 12 barrier elements are in the second operative position with the first 31, second 32, third 33 and fourth 34 windows misaligned and the first 21, second 22, third 23 and fourth 24 insulating walls of the first 11 and second 12 barrier elements overlapping one another in correspondence of the opening gap 4 between the contacts 2 and 3.

As shown in various embodiments in the attached figures, the insulating body 100 conveniently comprises a plurality of ventilation channels 160 that put said first 111 and second 112 cylindrical slots in communication with the outside of said insulating body 100. The ventilation channels 160 helps to remove thermal energy from the contact zone and in the direction of the exterior of the insulating body 100.

With reference to FIGS. 8-12, in various embodiments of the present disclosure and in order to further improve the arc-extinguishing capabilities of the switching apparatus 1, the latter may be conveniently provided with an arc splitter assembly 200 which in turn is provided with a plurality of arc splitter plates 201. An arc rail 202 extending from the opening gap 4 between the fixed 2 and movable 3 contact towards the arc splitter plates 201 may also be present according to known design.

The arc splitter assembly 200 is positioned in operative communication with the opening gap 4 between said fixed 2 and movable 3 contacts, according to specific design configuration that may vary according to the operative needs and applications.

It has been seen that the switching apparatus of the present disclosure is highly effective in controlling the arching phenomena, also in presence of short circuit conditions. Although particularly useful and suitable for DC applications, the presently disclosed electrical switching apparatus can be used also for AC applications.

From a manufacturing standpoint, the presently disclosed electrical switching apparatus is relatively easy to manufacture with consequent advantages in terms of costs.

It is therefore clear from the above that the switching apparatus of the present disclosure, fully meet the intended aims and purposes. Contingent shapes, materials, and dimensions can be any according to the needs and any variations in this respect shall be considered as part of the present disclosure.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

In the claims:

1. A switching apparatus for low and/or medium voltage applications, the switching apparatus comprising:
at least one electrical pole which comprises:
at least one fixed contact and at least one movable contact which can be coupled to/uncoupled from each other between a closed position in which they are in contact with each other and an open position in which they are separated from each other by an opening gap;
a first actuator configured to move said movable contact between said open and closed positions; and
an electrical insulating assembly comprising a first barrier element and a second barrier element which are each provided with at least a corresponding first and second insulating wall having a corresponding first and second window, wherein:
said first and second barrier elements are coaxially positioned with respect to each other along a longitudinal axis and are rotationally movable with respect to each other about said longitudinal axis between a first operative position and a second operative position,
in said first operative position, said first and second windows are aligned with each other, and in said second operative position, said first and second windows are misaligned with respect to each other, and
when said fixed and movable contacts are in the closed position, said first and second barrier elements are in said first operative position with the first and second windows aligned in correspondence of said opening gap, and when the fixed and movable contacts are in the open position, said first and second barrier elements are in said second operative position with the first and second windows misaligned and at least one of the first and second insulating walls of the first and second barrier elements overlapping said opening gap.

2. The switching apparatus, according to claim 1, wherein said first and/or second barrier element moves from said first operative position to said second operative position when said movable contact moves from said closed position to said open position, and
wherein said first and/or second barrier element moves from said second operative position to said first operative position when said movable contact moves from said open position to said closed position.

3. The switching apparatus, according to claim 1, wherein said first barrier element is fixed with respect to said fixed contact and said second barrier element rotates around said first barrier element between said first and second operative positions.

4. The switching apparatus, according to claim 1, wherein said first and second barrier elements are movable with respect to said fixed contact and counter-rotate with respect to each other between said first and second operative positions.

5. The switching apparatus, according to claim 1, wherein said first barrier element comprises:
an insulating body provided with an internal volume housing said fixed contact and open on one side of said insulating body and a first cylindrical slot open on an opposite side of said insulating body with respect to said internal volume,
wherein said first cylindrical slot and said internal volume are separated by said first insulating wall onto which said first window is formed.

6. The switching apparatus, according to claim 5, wherein:
said second barrier element comprises a first insulating cylinder open on one side and provided with a driving shaft on the opposite side,
a lateral surface of said first insulating cylinder forms said second insulating wall and is inserted into said first cylindrical slot of said first barrier element, and
said second window is formed on said second insulating wall.

7. The switching apparatus, according to claim 5, wherein said insulating body comprises a plurality of ventilation holes that put said first cylindrical slot in communication with an outside of said insulating body.

8. The switching apparatus, according to claim 5, wherein said insulating body is further provided with at least a second cylindrical slot which is open on the opposite side of said insulating body with respect to said internal volume, and
wherein said second cylindrical slot and said first cylindrical slot are separated by a third insulating wall onto which a third window is formed.

9. The switching apparatus, according to claim 8, wherein:
said second barrier element comprises a second insulating cylinder open on one side and positioned around said first insulating cylinder,
a lateral surface of said second insulating cylinder forms a fourth insulating wall and is inserted into said second cylindrical slot of said first barrier element, and a fourth window is formed on said fourth insulating wall.

10. The switching apparatus, according to claim 9, wherein:
in said first operative position, said first, second, third and fourth windows are aligned with each other, and in said second operative position, said first, second, third and fourth windows are misaligned with respect to each other, and
when said fixed and movable contacts are in the closed position, said first and second barrier elements are in said first operative position with the first, second, third and fourth windows aligned in correspondence of said opening gap, and when the fixed and movable contacts are in the open position, said first and second barrier elements are in said second operative position with the first, second, third and fourth window misaligned and with the first, second, third and fourth insulating walls of the first and second barrier elements overlapping one another in correspondence of said opening gap.

11. The switching apparatus, according to claim 10, wherein said insulating body comprises a plurality of ventilation channels that put said first and second cylindrical slots in communication with an outside of said insulating body.

12. The switching apparatus, according to claim 1, further comprising an arc splitter assembly provided with a plurality of arc splitter plates, wherein said arc splitter assembly is positioned in operative communication with said opening gap between said fixed and movable contact.

13. The switching apparatus, according to claim 1, further comprising a second actuator configured to move said first and/or second barrier element between said first operative position and said second operative position.

14. The switching apparatus, according to claim 13, wherein said second actuator is synchronized with the first actuator of said movable contact.

15. The switching apparatus, according to claim 1, wherein said movable contact is linearly or rotationally movable between said open and closed positions.

16. The switching apparatus according to claim 12, wherein said arc splitter assembly is further provided with an arc rail extending from said opening gap between said fixed and movable contact towards said arc splitter plates.
